(19) United States
(12) Patent Application Publication
(10) Pub. No.: US 2001/0020296 A1
(43) Pub. Date: Sep. 6, 2001

(54) Method and system for generating revenues for space missions

(76) Inventor: Charles M. Chafer, Houston, TX (US)

Correspondence Address: George T. Marcou, Kilpatrick Stockton LLP, Suite 800, 700 - 13th Street, N. W., Washington, DC, 20005, US

(21) Appl. No.: 09/811,540

(22) Filed: Mar. 20, 2001

Related U.S. Application Data
(60) Provisional application No. 60/228,752, filed on Aug. 30, 2000.

(51) Int. Cl. H04N 7/16

(52) U.S. Cl. 725/1

(57) ABSTRACT

A novel method for generating revenues in space missions is provided. The method includes: creating an advertisement related to a creative audiovisual work; receiving payment for the display or presentation of the advertisement in conjunction with the space mission; and displaying or presenting the advertisement in conjunction with the space mission. Preferably, the audiovisual work is selected from one or more of a movie or motion picture, a television show or program, a film, a video, or a webcast. The present invention provides significant advantages over existing methods of generating revenues in relation to space missions and significantly enhances the development of space missions and technology.

This application claims priority to Provisional Application No. 60/228,752, filed Aug. 30, 2000. The disclosure of said Provisional Application is incorporated by reference in its entirety as though recited herein in full.

The present invention is related to applicant's co-pending provisional patent application entitled System and Method for Public Participation in Space Missions and to applicant's co-pending provisional patent application entitled Spacecraft Advertisement Method And System, both of which applications are to the present inventive entity and have the same filing date of the present application, the entire disclosures of which are incorporated herein by reference.

### BACKGROUND OF THE INVENTION

1. Field of the Invention

The present invention relates to methods and systems for generating revenues in space missions.

2. Description of the Related Art

Historically, revenue generation in space missions has been through governmental funding, private industry funding and other limited means.

There remains a great need for new revenue generating systems and methods in relation to space missions. It is well known that space missions are highly expensive. This great expense creates a substantial barrier to rapid advancements in space flight, and, hence, to rapid advancements in technology and in society in general.

Despite the high costs of space travel, the assignee of the present invention, Encounter 2001, LLC (see http://www.encounter2001.com), is bringing real space missions more directly to the public by, for example, enabling members of the public to send personal data (e.g., written information, images and the like) and material (e.g., personal DNA samples, such as hair samples) into space as participants in actual space missions. In addition, Celestis, Inc., an affiliate of Encounter 2001, LLC has successfully launched cremation burial space flights—e.g., including space burials of the famous celebrities Timothy Leary and Gene Roddenberry.

The present assignee has discovered that methods and systems of generating revenues in space missions can be significantly improved upon. By bringing new methods and systems of generating revenues in space missions, the present assignee strives to bring space missions more directly to the public, and to increase revenues and funds for space missions.

### SUMMARY OF THE INVENTION

The present invention overcomes various limitations of existing revenue generating methods and systems for space missions.

In one embodiment, revenues are generated in space missions by uniquely tying space missions with promotions of creative audiovisual works including movies, film, television, video or the like. Preferably, advertisement space is sold to commercial entities that sell directly to the general public, and, more preferably, directly to members of the general public that are public participants in the space mission. In one preferred application of the first embodiment, revenues are generated in relation to space missions by the sale of corporate billboards or the like advertisement space located on the exteriors of spacecrafts.

In some preferred embodiments, the space missions are funded by multiple revenue sources, including, for example, corporate sponsors and public participants. Additionally, the space missions may also be concurrently funded through additional revenues sources, including, for example, through science and education institutions, governmental funding and more.

The above and other aspects, features and advantages of the invention will be further appreciated in view of the following description of the preferred embodiments of the invention.

### BRIEF DESCRIPTION OF THE DRAWINGS

The present invention is shown by example, and not limitation, in the accompanying Figures, in which:

FIG. 1 is a schematic diagram of a spacecraft having an advertisement distant from the earth's surface;

FIG. 2(A) is a schematic diagram of a spacecraft having a solar sail;

FIG. 2(B) is a schematic diagram of a solar sail having an advertisement thereon; and

FIG. 3 is a schematic diagram of a spacecraft and carriercraft system including multiple on-board components and revenues sources.

### DETAILED DESCRIPTION OF THE PREFERRED EMBODIMENTS

Tying Space Missions to the Promotions of Creative Audiovisual Works

According to preferred embodiments of the present invention, revenues are generated in space missions by uniquely tying space missions with the promotions of goods or services including, most preferably, specific creative audiovisual works such as movies, film, television programs, video and/or the like.

Preferably, advertisement space is sold to companies, corporations or other commercial entities that sell products and/or services to the general public or to sectors of the general public. In one illustrative application of the first embodiment, revenues are generated in relation to space missions by the sale of corporate billboards or the like advertisement space located on the physical spacecrafts themselves. These advertisements are preferably viewable via remote cameras (e.g., mounted on spacecraft carriers that deploy the spacecraft in the upper atmosphere or space or on reusable orbital platforms such as a space shuttle or a space station, etc.) or via terrestrial means such as earth-based telescopes or the like.

The present invention can thus provide a great incentive to corporate and the like sponsors, that hitherto had no reason to contribute to space missions, to participate as significant sources of revenue by purchasing spacecraft advertisements and sponsorship of space missions.

Moreover, tying corporate advertisements to specific creative audiovisual works and the like, greatly enhances the ability of generating revenues via corporate advertising and sponsorship.

In some preferred embodiments of the invention, the advertisements (e.g., preferably displayed on the exterior of the spacecraft) provide promotions of creative works including audio and visual/video components, such as, for instance, one or more of the following: movies, film and/or motion pictures (e.g., STAR WARS, MEN IN BLACK, ALIENS or any other movie or motion picture); television programs or shows (e.g., STAR TREK, THE X-FILES, or any other program or the like); videos (e.g., various movie or other video releases); creative webcasts or Internet broadcasts.

In preferred embodiments of the invention, the advertisements are for commercial entities that sell such products or services to the public. In more preferred embodiments of the invention, the advertisements provide promotions of products that are purchased by actual participants in the space mission. For example, where the space mission includes an educational aspect, the advertisements may be for companies that sell substantially to school children or for products sold substantially to school children, such as rated G movies (e.g., DISNEY movies and the like), as well as clothing (e.g., jeans, shoes and sneakers), sporting goods or the like.

In some embodiments, the advertisements can include: a company name (e.g., ENCOUNTER 2001, LLC as shown, or PARAMOUNT PICTURES or the like); a company logo (e.g., such as a picture of a LION or the like); a company slogan (e.g., such as “I'LL BE BACK” or the like); an image of a famous individual such as a company spokesperson or an actor in a film or the like; an offer made by the company to its consumers (e.g., “buy one get one free” or the like); sale information provided by the company to its consumers (e.g., “end of the millennium sale” or the like); a company web page address, URL or other computer accessible user interface address (e.g., http://www.encounter2001.com); and/or any other company identifiers or information to be provided to its consumers.

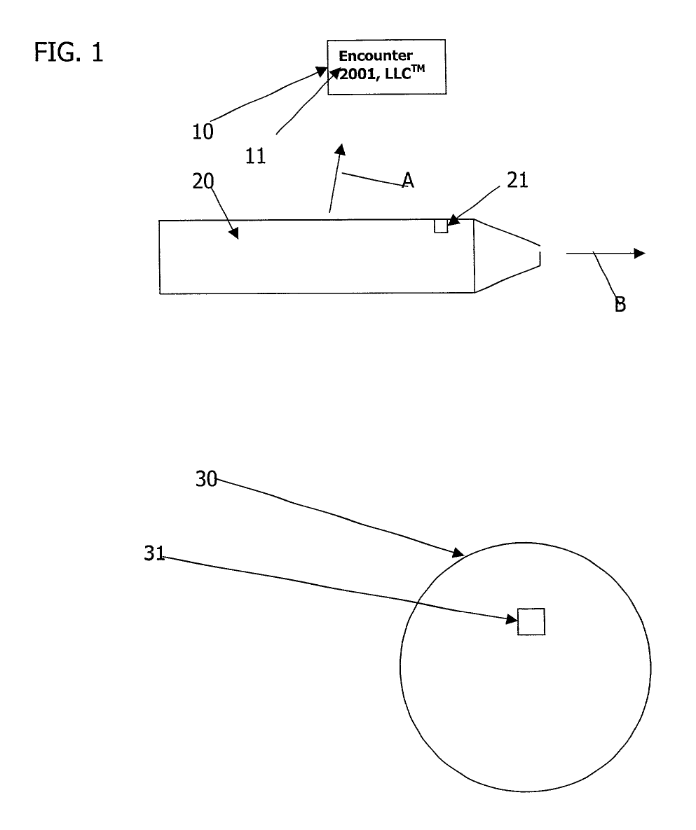

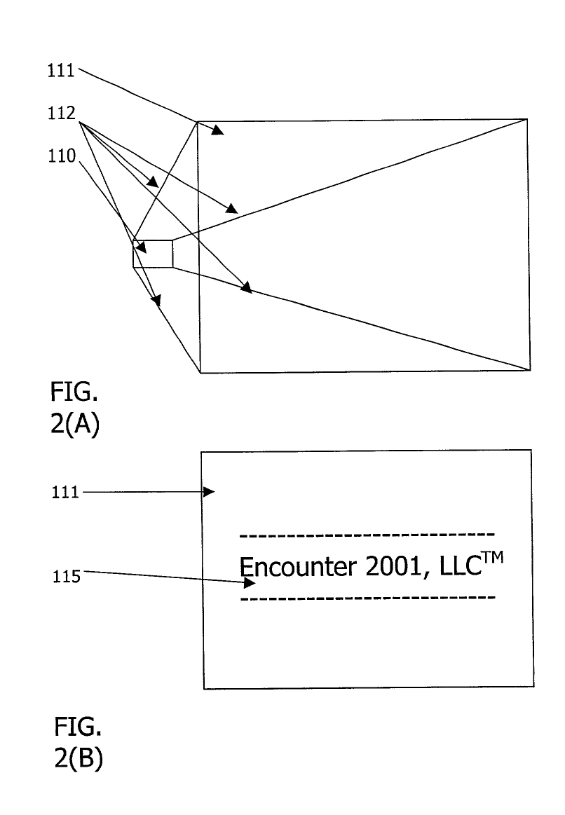

FIGS. 1, 2(A) and 2(B) illustrate some exemplary, and non-limiting, methods of providing space mission advertisements for commercial entities. With reference to FIG. 1, according to a first preferred embodiment of the invention, a spacecraft 10 is provided with a region on an external surface thereof for one or more advertisement. In the illustrated embodiment, the advertisement reads “Encounter 2001, LLC™.”

In the embodiment shown in FIG. 1, the spacecraft 10 follows a path A away from and out of the earth's atmosphere. As also shown in FIG. 1, the spacecraft is preferably initially mounted upon a carriercraft 20 that is designed to carry the spacecraft to a predetermined altitude (e.g., from within the earth's atmosphere into outer space) and to then deploy the spacecraft 10. In the embodiment of FIG. 1, the carriercraft 20 may follow, e.g., a path B generally transverse to the path A of the spacecraft. The carriercraft 20 can include, for example, a rocket, a reusable orbital platform or another carrier craft.

Preferably, the spacecraft is launched as a secondary payload. In one exemplary embodiment, it is included on an ARIANE 5 rocket. In one example, the ARIANE 5 rocket can be used to place a small spacecraft in geo-synchronous transfer orbit. At a certain point in time (e.g., coordinated with television broadcasting, web casting, etc.), the spacecraft can be propelled along a particular path—e.g., out of the earth's atmosphere.

Alternatively, the spacecraft 10 can follow any known trajectory or path. In just one of many illustrative embodiments, the spacecraft may be sent on a trajectory away from our planet's solar system. In one illustrative example, the spacecraft 10 may initially be launched into an earth geo-synchronous transfer orbit (GTO) as an intermediate orbit. Then, the spacecraft 10 may be propelled by an internal rocket motor to another planet, e.g., Jupiter, to use the planet's gravity to boost itself on a trajectory outside of the solar system. The spacecraft 10 can also be directed into other known trajectories, such as into orbit around the earth, around the sun or along another path.

As shown in FIG. 1, the spacecraft is uniquely adapted so as to include an advertisement 11 on the external surface thereof. In the preferred embodiment, this advertisement is mounted in such a manner to enable viewing of the advertisement upon deployment of the spacecraft 10 from the carrier 20. That is, the advertisement 11 is, in some preferred embodiments, viewable upon deployment of the spacecraft 10—and, in preferred embodiments, not upon the initial launch of the carrier 20 (e.g., typically from the earth's surface).

Accordingly, a spectacular advertisement can be created that is viewed in space. The image of the advertisement in space is most preferably transmitted to numerous consumers of goods or services sold by the advertising entity, and most preferably, in substantially real time.

In one preferred embodiment, the advertisement 11 is viewed via a video camera 21 supported by the carriercraft 20. In this latter embodiment, the system preferably sends signals to the earth for viewing. In this case, the advertisement position on the spacecraft, the video camera 21 location and the deployment of the spacecraft 10 should be coordinated so that the video camera 21 will have a substantially direct view of the advertisement 11 for a period of time to allow viewing during deployment. Preferably, in some embodiments, the video transmission is broadcasted in substantially real time for television viewing. Preferably, in some embodiments, the video transmission is additionally or alternatively transmitted over a computer network for access by consumers of the advertised products or services via their personal computers or the like, such as over the Internet or the World Wide Web. This Internet or webcast transmission is most preferably performed in substantially real time. In the latter case, the video transmission may be limited to smaller video clips or pictures where transmission bandwith is limited. When an advertisement is displayed on the Internet, a web page or the like displaying the advertisement may also be provided with a link to an address, e.g., via a uniform resource locator (URL), of a web page of the advertising entity to direct the consumers to render purchases or to receive additional information. In some embodiments, the web cast can include a streaming media presentation that is transmitted to a local computer of a member of the public only after receipt of payment therefore, the payment being made on-line via credit card, virtual wallet or other electronic payment means. The playback of the streaming media can be carried out by a suitable streaming media player, which could be executing on the user's local computer as a plug-in module for a browser application. Some examples of suitable streaming media players include the MICROSOFT MEDIAPLAYER, the APPLE COMPUTER QUICKTIME and the REALVIDEO or REALPLAYER programs provided by REAL NETWORKS. In addition, the present invention could use other available streaming players.

Preferably, the website also provides video imaging to enable users to follow the progress of the mission—e.g., from the design, to the construction, to the launch of the space craft and/or to the spacecrafts deployment from a carriercraft or departure from the solar system. Corporate sponsors having advertisements on the spacecraft may, thus, even generate advertising for many years after the initial launch and broadcasting, by maintaining video imaging and progress information in relation to the ongoing mission.

In another preferred embodiment, as shown in FIG. 1, the advertisement can be viewable from earth 30, e.g., via an earth-based telescope 31. In some preferred embodiments, the telescope 31 can be a large commercial telescope and images obtained therewith can be recorded and transmitted—as in the preceding embodiment—to consumers via television broadcasting, Internet broadcasting and/or other forms of image broadcasting. Moreover, the images can also be reproduced within newspapers, magazines, and other materials. Moreover, the images can also be reproduced onto assorted secondary items such as T-shirts, coffee mugs, plates, posters and other displayable novelty items.

FIGS. 2(A) and 2(B) illustrate one preferred embodiment of the invention wherein a spacecraft 100 is used that includes a solar sail 111. In this latter embodiment, the advertisement 115 is most preferably located on the solar sail 111. As is known in the art, solar sails can be used to power spacecraft via reflection of solar and the like radiation. See, e.g., U.S. Pat. Nos. 5,850,992 (Method for Controlling the Pitch Attitude of a Satellite By Means of Solar Radiation); U.S. Pat. No. 5,183,225 (Spacecraft That Utilizes Sight Pressure and Method of Use); U.S. Pat. No. 4,909,460 (Device and Method for Aiming a Space Probe Toward a Celestial Body); U.S. Pat. No. 4,759,517 (Station-Keeping Using Solar Sailing); U.S. Pat. No. 4,614,319 (Solar Sail), the entire disclosures of which are incorporated herein by reference. Solar sails may be made with expansive surface areas—e.g., multiple kilometers in width—upon which very large advertisements can be displayed. In some embodiments, the solar sails could potentially be viewable by consumers or laymen with moderate telescopes, binoculars or the like; in these latter embodiments, the advertisements would have very substantial visual impact upon the viewing consumers of the products or services sold by the advertising entity.

Multiple Revenue Sources

According to another embodiment of the present invention, revenues are preferably generated in relation to space missions from a variety of revenue sources. Hitherto, the number of revenue sources was limited.

According to embodiments of the invention, a number of revenue sources are made available in relation to space missions. In addition, the present invention can significantly increase proceeds received via various existing revenue sources.

Public Participation Revenue Sources

In the most preferred embodiments of the invention, the spacecraft 10, 100 is a utilized, at least in part, for a public participation space mission. Preferably, members of the public can render payments in order to act as participants in the space mission. For example, by contributing $X dollars, members of the public may be able to provide data, images, statements, material, objects or other information or the like of individual consumers that is carried within the spacecraft 10, 100. In this manner, the public consumers should have a heightened personal interest in the space mission, greatly enhancing advertisement value for the advertising companies. Preferably, the public participation component of the space mission is only one component of the entire space mission. For example, the carriercraft 20 preferably contains government, scientific and/or other cargo, experiments and the like. Accordingly, the present invention provides a significant means for defraying costs in space missions, benefiting all entities utilizing the carriercraft.

In some preferred embodiments, an Internet web site or other on-line graphical user interface is provided which provides on-line entry forms with which members of the public can input information (e.g., data to be included in the space mission) and can render payments (e.g., via credit cards, on-line accounts, virtual wallets, or the like). Preferably, the web site also includes links or pages for rendering purchases for secondary items and/or links or pages for purchasing goods or services, e.g., movie tickets or the like, sold by commercial advertisers or sponsors of the space mission.

In some preferred embodiments, an Internet website or the like can be provided with a web cast (e.g., a streaming media presentation or the like) of the space mission and members of the public can render payments (e.g., preferably on-line) to be provided with such a web casting. In this manner, revenues can be generated by, for example, providing a pay-per-view type of Internet-based or web-based broadcast. In some embodiments, the web cast can be made available only to members of the public that are participants in the mission; in this latter case, the original participation fee may include the costs for viewing web casts and/or additional charges can be incurred to view certain web casts.

In one embodiment, a member of the general public, and most preferably a customer participating in a public participation component of a space mission, may be selected and/or may render payment to perform a pre-determined task in relation to the space mission—such as, for example, pressing a button that actuates a stage in the technical process of the space mission, such as launch of the spacecraft from a carriercraft, initiation of propulsion of the spacecraft, initiation of broadcasting of video images from a camera showing the spacecraft or participation in another space mission technical process.

Corporate Participation Revenue Sources

As set forth herein, the present invention enables corporate and the like sponsors to participate via spacecraft advertisements and sponsorship of space missions.

The unique methods of corporate advertisement—e.g., advertisement by corporations that sell products or services, including audiovisual works, to the public (e.g., especially to members of the public that are actual participants in the space mission)—greatly enhance the ability to generate revenues via corporate advertising and sponsorship.

Educational Revenue Sources

In some embodiments, an education component can be provided to supplement capital investment and publicity strategies.

For example, primary sales (e.g., sales of public participation features, etc.) and secondary product sales (e.g., sales of T-shirts and various other secondary items) can be greatly stimulated by incorporating educational components—and especially educational components wherein public individuals are actual participants. While this educational aspect should greatly increase participation by school children, and in certain cases college students, it should also increase participation by family members, friends and other members of the public.

Moreover, revenues should also be greatly increased through corporations and the like that will benefit by the strong publicity involved in its sponsorship of a space mission incorporating such educational initiatives.

In some exemplary embodiments, one or more school can place a small experiment on board the spacecraft. In addition, revenue sources can be generated through educational contests in relation to space missions. In some preferred embodiments, a competition or contest can be established for a chosen school to place a small experiment on the spacecraft.

In some preferred embodiments, the educational component includes a website that includes one or more of a number of aspects in relation to the educational component. First, the website can include forms and other information to enable students, schools and/or other entities to obtain contest rules, etc., and to sign up and/or submit entries for a contest or the like. Second, the website can include educational information related to the educational component, such as a description of an experiment to be conducted and the principles related thereto. Third, the website can include an interface for students and/or other individuals to communicate within on-line chat rooms in relation to the space mission. Fourth, the website can be provided with a data-stream directly from the spacecraft itself to a web site server computer (e.g., transmitted via satellite communication or the like and then via the Internet or other network).

In the latter example, the data-stream can include, for example, substantially real-time data related to results of the educational component, such as results of an experiment. Moreover, the data could also include video or picture images of the educational component. Accordingly, students and/or the general public may be able to view the educational component (preferably, aspects thereof demonstrating degree of success or failure of an educational experiment or the like). In some embodiments, the data delivered from the spacecraft can be retrieved by (e.g., at a particular web page or URL) or transmitted to (e.g., via e-mail or the like) the participants in the experiment for further analysis in relation thereto. Additionally, a contest could be created that is awarded to the first school or the like to appropriately analyze the transmitted data. Additionally, in various embodiments discussed herein involving prizes, rather than awarding one prize, a number of prizes could be awarded so as to have a large number of winners. For example, all or most participants or all participants that successfully analyze the experiment within a time period or the like may receive coupons (e.g., from a sponsor), novelty items or other materials (e.g., from a sponsor) or the like.

Additionally, an educational component can also include class room or the like kits or distribution materials, such as, for example, a teachers' guide, and introductory letter, membership materials for students, posters, forms for the students to fill in or the like. Preferably, the students can submit information that may be displayed on the website in relation to participant team information (e.g., photographs, names or the like). Among other things, the website can serve not only to publicize the educational initiative, but it can provide a low cost means to distribute curriculum materials to schools.

Sporting Space Mission Revenue Sources

In another preferred embodiment, the spacecraft 10, 100 can be a craft used in a spacecraft race. Preferably, the spacecraft race is between multiple solar sail powered spacecraft. The spacecraft race can be, for example: a) a race around another planet, e.g., mars or another planet; b) a race around the moon; c) a race around the earth; or c) a race along another desired race flight path. The spacecraft race may alternatively be a race to be the first spacecraft to achieve a particular task—e.g., such as the first solar sail spacecraft to successfully fly a particular distance, or to orbit the moon, or to orbit mars or the like. This latter form of “race” would attract significant media attention in a manner parallel to the media attention received by various individuals seeking to sail in a balloon around the circumference of the earth. Revenues can be generated in relation to sales of corporate sponsorship for the race, by sales of secondary race items (e.g., T-shirts and the like), and other means capitalizing on the media attention thereof. Additionally, gambling revenues, where legal, can be generated by hosting betting in relation to such races. In the latter case, preferably, an on-line betting web site is provided where members of the public can enter bets and render payments.

Other Known Revenue Sources

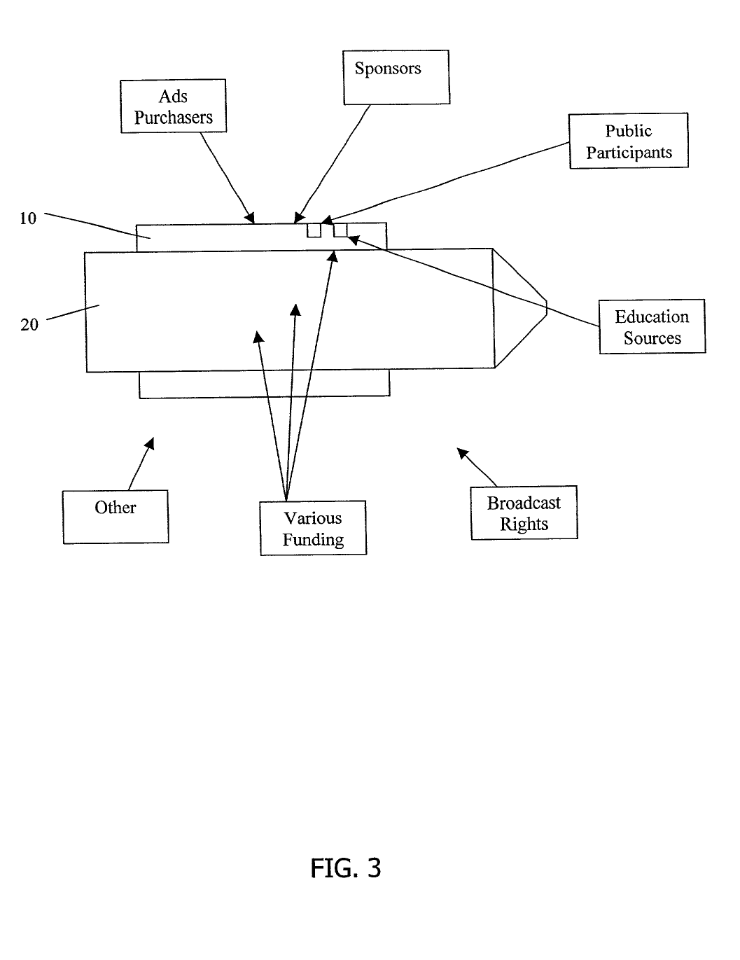

As in many existing space missions, revenues can also be generated via scientific institution participation, government participation in the space mission, and/or via any other means known for generating revenues in relation to space missions. It should be understood by those in the art, as illustrated schematically in FIG. 3, that all or some of the various revenue source components of the space mission described herein can be combined together in a single space flight mission.

While the present invention has been described above with respect to preferred embodiments of the invention, the present invention is not limited thereto, but encompasses all other modifications, variations and embodiments that would be apparent to those in the art based on this disclosure.

What is claimed is:

1. A method of funding a space mission by tying the space mission to a for-profit creative audiovisual work, comprising:
a) receiving funds from the owner of a creative audiovisual work;
b) using the funds to finance, at least in part, a space mission;
c) using the space mission as a medium for advertising the creative audiovisual work to attract sales of the creative audiovisual work to members of the public; and
d) charging members of the public to view the creative audiovisual work.

2. The method of claim 1, further including charging members of the public to view the space mission.

3. The method of claim 2, further including charging members of the public to view the space mission via a web casting over the Internet or other computer network.

4. The method of claim 3, wherein said web cast includes a streaming media presentation that is transmitted to a local computer of a member of the public only after receipt of payment therefore, said payment being made on-line via credit card, virtual wallet or other electronic payment means.

5. The method of claim 1, wherein the audiovisual work is selected from the group consisting of a movie or motion picture, a television show or program, a film, a video, or a webcast.

6. A method of generating revenues in space missions, comprising:
a) creating an advertisement related to a creative audiovisual work;
b) receiving payment for the display or presentation of the advertisement in conjunction with the space mission; and
c) displaying or presenting the advertisement in conjunction with the space mission.

7. The method of claim 6, wherein the audiovisual work is selected from the group consisting of a movie or motion picture, a television show or program, a film, a video, or a webcast.

8. The method of claim 6, further including receiving payment from members of the public for public participation in the space mission.

9. The method of claim 8, wherein the public participation includes providing personal data and/or material of individual participants along with a spacecraft of the space mission.

10. The method of claim 6, further including providing the advertisement on the periphery of a spacecraft in the space mission, providing a camera on a carriercraft carrier from which the spacecraft is deployed, obtaining images of the spacecraft after deployment which show the advertisement and transmitting the images for reproduction or broadcast to the public.

11. The method of claim 6, further including providing the advertisement on the periphery of a spacecraft in a space mission, providing a telescope or the like on the earth from which images of the advertisement located on the advertisement location can be seen, and transmitting the images for reproduction or broadcast to the public.

12. The method of claim 6, wherein said spacecraft includes a solar sail and said advertisement is along a surface of the solar sail.
